(19) United States
(12) Patent Application Publication
(10) Pub. No.: US 2012/0160662 A1
(43) Pub. Date: Jun. 28, 2012

(54) Pyrolisis Reactor and Process for Disposal of Waste Materials

(75) Inventors: Ahmed Al-Shamma'a, Liverpool (GB); Rafid Al Khaddar, Gatley (GB)

(73) Assignee: MICROWASTE LIMITED, Liverpool (UK)

(21) Appl. No.: 13/382,538

(22) PCT Filed: May 26, 2010
(86) PCT No.: PCT/GB2010/050869

§ 371 Date: Mar. 13, 2012

(30) Foreign Application Priority Data
Jul. 7, 2009 (GB) 0911777.1

(51) Int. Cl. B01J 19/12; B01J 19/08

(52) U.S. Cl. 204/157.15; 422/186

(57) ABSTRACT

Disclosed is a pyrolysis reactor for processing waste, comprising: a reactor chamber; a source of microwave energy, wherein the reactor chamber comprises a material which is operable to produce a plasma in the presence of the microwave energy. Also disclosed is a corresponding method.

The present invention relates to a system and apparatus for treating waste material, such as waste foods and/or other biomass, which is typically thrown away and eventually ends up in landfill. Embodiments of the invention utilise microwave plasma pyrolysis as a process to decompose the organic materials comprised in the waste material to yield useful by-products which have one of a variety of uses.

Every year, in the United Kingdom alone, approximately one third of all food that is purchased is thrown away. This amount of waste represents a vast problem in that it is normally buried in landfill refuse sites where it slowly decomposes, releasing methane gas, which is one of the most potent greenhouse gases and is, therefore, a significant contributor to climate change. When waste food is disposed of, also wasted is all the carbon involved in its production while it was grown, processed, transported and stored. In the UK, the food supply chain accounts for around 20% of greenhouse gas emissions. If it were possible to avoid throwing away all such food, then the carbon savings would be equivalent to removing approximately one in five cars from the road system. Clearly, it will not be possible to avoid all waste, but any systems which are able to successfully extract useful energy and other products from such waste material, whilst also reducing the amount of harmful methane gas released, would be most beneficial.

The process of pyrolysis is the decomposition of organic materials by heating in the absence of oxygen, which leads to the production of few air emissions. The products of pyrolysis are typically char (charcoal), tar (a low viscosity brown liquid containing water, which is also referred to as bio-oil) and gases including hydrogen (H₂) and carbon monoxide (CO). Also produced are methane (CH₄) and carbon dioxide (CO₂). The mixture of hydrogen and carbon monoxide is known as syngas.

Pyrolysis is always the first step in combustion and gasification processes, where it is followed by total or part oxidisation of the primary products. Any one of the process characteristics can be changed, and different products can be obtained. For instance, a relatively lower process temperature and longer vapour residence time tend to favour the production of charcoal. A relatively higher temperature and longer vapour residence time tend to increase the biomass conversion to gas. A relatively moderate temperature and short vapour residence time tend to produce liquids. Table 1 below indicates an approximate product distribution obtained from different modes of the pyrolysis process. There is currently a particular interest in the fast pyrolysis process for liquid production.

TABLE 1

| Technology | Reaction Conditions | Liquid | Char | Gas |
|---|---|---|---|---|
| Fast Pyrolysis | Moderate temperature, | 75% | 12% | 13% |
| | short residence time, | | | |
| | particularly vapour | | | |
| Carbonisation | Low temperature, vary long | 30% | 35% | 35% |
| | residence time | | | |
| Gasification | High Temperature, long | 5% | 10% | 85% |
| | residence times | | | |

Prior art pyrolysis systems for the decomposing of organic materials are already known. For instance, U.S. Pat. No. 4,831,944 (Process and Device for Destroying Solid Waste by Pyrolysis) relates to a process and device for destroying solid waste by pyrolysis, in which a column of such waste is upwardly traversed at least partially by a stream of hot gas blown in at the base of said column, wherein said stream of hot gas is generated by at least one plasma jet. This application claims to result in the destruction of non-burned residues and an improved flow of the molten residues.

It is an aim of embodiments of the present invention to more efficiently process domestic food waste by a process of pyrolysis. Embodiments of the present invention aim to address shortcomings with prior art pyrolysis systems, whether mentioned herein or not.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

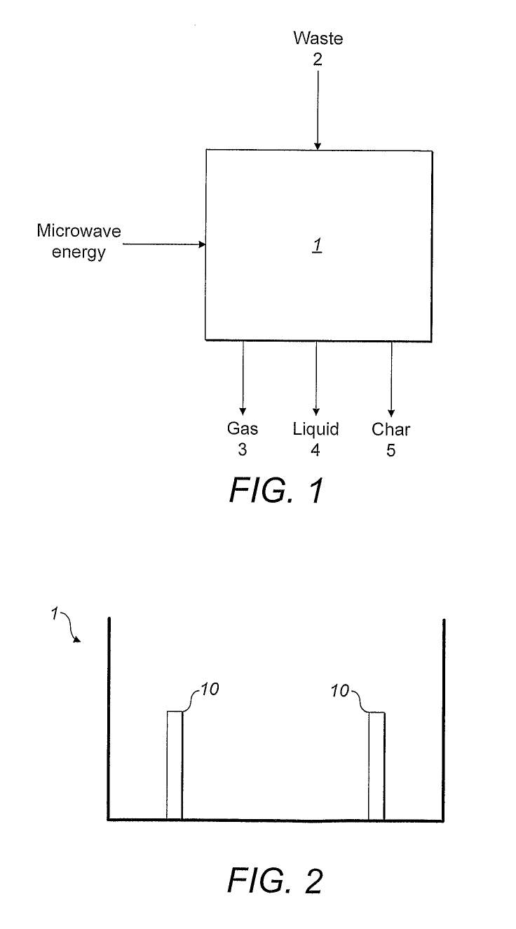

FIG. 1 shows a schematic of the pyrolysis process according to an embodiment of the present invention, showing inputs and possible outputs; and

FIG. 2 shows a cross-section through a reaction chamber according to an embodiment of the invention.

Embodiments of the present invention provide a new system of high efficiency microwave plasma pyrolysis to be used in processing domestic food waste. The combination of microwave power, together with means for generating a plasma within the waste provides an efficient and effective pyrolysis system.

The by-product of the process is in the form of carbon, gas or oil with a potential use as a biofuel and the dry solids can be used as animal feed which, advantageously, are free of bacteria or pesticides since the product has been subjected to microwave irradiation. The microwave plasma pyrolysis reactor according to an embodiment of the invention combines both direct heating and plasma that is able to operate at a low power whilst still producing the required high temperature for waste treatment.

FIG. 1 shows a generic schematic of the system according to an embodiment of the present invention. The pyrolysis reactor 1 receives microwave energy from a microwave source (not shown) and waste 2. The waste is added in a batch fashion, rather than in an continuous stream, although other embodiments of the invention may use a continuous stream.

The operating conditions of the reactor are varied to produce the desired mix of Gas 3, Liquid 4 or char 5 outputs. The operating conditions of power and temperature, for example, will be based upon the volume of waste to be treated. Embodiments of the invention can be made in a modular fashion, which allows a multi-stage approach to pyrolysis to be adopted (see later for more details). This allows the operating conditions to be fine-tuned according to the type and volume of waste.

Inside the reactor 1, the waste can be heated by the presence of the plasma, to a temperature as high as 8000° C. As shown in Table 1, in order to produce a gas phase as the main by-product, the reactor temperature should be ‘high’ (at least 800° C.). In order to produce the main by-product in the liquid phase, then the reactor temperature should be ‘moderate’ (approximately 300-450° C.).

The source of microwave energy is a commercially available magnetron unit. The power rating is selected according to the volume of the reactor unit 1. For instance, a 30 kW unit is suitable for use with a reactor 1 having dimensions of approximately 40×40×40 (cm). A more powerful magnetron unit, rated at 75 kW is more suitable for larger reactors.

If a magnetron unit having a power of the order of 75 kW is used, it is tuned to operate at a frequency of 896 MHz, which is optimised to operate with food waste. This frequency is selected on the basis of the water content of typical food waste. Other material, having a different composition, may benefit from a different frequency or range of frequencies. In a preferred embodiment of the invention, a magnetron having a tunable frequency is used to offer flexibility over the type of waste which can be treated. The range of frequencies which are preferred are 896 MHz to 5.8 GHz.

The reactor 1 is a chamber which is closable with a tightly-fitting lid to ensure that oxygen is excluded. The waste 2 is introduced, the lid is closed and the microwave energy is applied to commence the pyrolysis reaction. Furthermore, in an alternative embodiment, the waste can be loaded onto a conveyor belt, and the microwave energy can be applied thereto by use of a microwave horn antenna.

The microwave source is directly coupled to the reaction chamber 1. Other possible coupling means are possible, including waveguides, cables and antennas.

To improve the efficacy of the pyrolysis reaction, a plasma is generated within the reaction chamber 1. Such a plasma is defined as being a partially ionised gas in which a certain proportion of electrons are free, rather than being bound to an atom or molecule. The plasma itself is able to achieve a high temperature in the presence of microwaves.

The plasma is produced by the action of the microwaves on a material within the reaction chamber 1. FIG. 2 shows a cross-sectional view of the reaction chamber 1, in which a plurality of carbon rods 10 extend from the base of the chamber. The action of the microwaves on the carbon causes a plasma to be produced. The plasma improves the efficacy of the pyrolysis reaction without requiring a significant increase in power from the magnetron. The presence of the plasma in the chamber increases the efficiency of the process by approximately 40% compared to the use of microwave power alone. The reactor temperature can reach 8000° C. for a given microwave power.

Carbon is one of several possible materials for the rods 10. Other materials include any one of a plurality of metals or Boron. Furthermore, the char that is produced as part of the pyrolysis process can also be used as a source of plasma inside the reactor.

The rods 10 are shown extending from the base of the reaction chamber 1 as, in this way, they are less likely to interfere with the loading of the waste and the removal of the char at the end of the process. However, the rods 10 can be positioned to extend downwardly from the lid, outwardly from the walls of the chamber or any combination thereof.

In a preferred embodiment, the reactor can be made substantially self-fuelling. If the reaction conditions are optimised to produce a desired output—preferably gas or liquid—then the output can be used to produce electrical power to power the magnetron. Such a configuration is advantageous if the reactor is to be used in a remote location, for instance. In any event, being able to make use of one of the by-products to power the process is a desirable outcome.

The output of the pyrolysis process results in more useful products than prior art incineration methods, and the output(s) can be used as fuel or purified and used as feedstock for petro-chemical and other applications. The syngas can be used to generate electricity efficiently via a gas engine or fuel cell. Prior art incineration techniques generate energy less efficiently via steam turbines.

The energy produced by use of embodiments of the invention may be eligible for renewable energy certification schemes, which may have the potential for increased income from any energy so generated.

In another embodiment, a plurality of reactor chambers 1 can be provided, each operable under different conditions to extract different by-products. The output of a first reactor can be fed into a second, the output of which is fed into a third and so on. In this way, the optimum conditions can be derived for a sequential processing of the waste 2.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A pyrolysis reactor for processing waste, comprising:
a reactor chamber;
a source of microwave energy, wherein the reactor chamber comprises a material which is operable to produce a plasma in the presence of the microwave energy.

2. A pyrolysis reactor as claimed in claim 1 wherein the source of microwave energy is a magnetron.

3. A pyrolysis reactor as claimed in claim 2 wherein the magnetron is directly coupled to the reactor chamber.

4. A pyrolysis reactor as claimed in claim 1 wherein the material which is operable to produce a plasma is provided in the form of one or more rods projecting from an interior surface of the reactor chamber.

5. A pyrolysis reactor as claimed in claim 1 wherein the material which is operable to produce a plasma is one of: a metal; boron; and carbon.

6. A pyrolysis reactor as claimed in claim 1 wherein the reactor chamber is provided with a lid which is operable to provide a substantially airtight seal to the interior of the reactor chamber.

7. A pyrolysis reactor as claimed in claim 1, operable to produce varying proportion of solid, liquid or gas by-products in accordance with predetermined operating parameters.

8. A pyrolysis reactor as claimed in claim 1 wherein the source of microwave energy is tuneable in the range: 896 MHz to 5.8 GHz.

9. A method of processing waste comprising the steps of:
supplying waste to a pyrolysis reactor provided with a means for producing a plasma in the presence of microwave energy;
applying microwave energy to the reactor to pyrolyse the waste.

10. The method as claimed in claim 9 wherein the waste is either provided in a batch or via a continuous stream.

11. The method of claim 10 wherein if the waste is provided via a continuous stream, then a conveyor belt is used and the microwave energy is provided via a horn antenna.
